(19) United States
(12) Patent Application Publication
(10) Pub. No.: US 2012/0301703 A1
(43) Pub. Date: Nov. 29, 2012

(54) Labock fire resistant paint

(76) Inventor: Joseph Labock, Pembroke Pines, FL (US)

(21) Appl. No.: 13/134,052

(22) Filed: May 27, 2011

(51) Int. Cl. B32B 5/02; B32B 9/00; B32B 18/00; B32B 27/42; B32B 27/00; B32B 17/02; B32B 27/40

(52) U.S. Cl. 428/304.4; 428/426; 428/221; 428/697; 428/702; 428/704; 428/524; 428/447; 428/446

(57) ABSTRACT

A fire and heat resistant composition for providing or enhancing the fire resistance of a material. The composition consists of both chemical and physical integration. Physical application is a coating composition containing materials including a fire and heat resistance means, lower peak heat release means, lower heat released per unit time means, higher temperature gradient means, low flame spread means, high ignition delay means, low peak heat release means, low total heat release means, high thermal stability means, elastic and coating thickness encasement means and heat. Chemical applications consist of chemical additive which are naturally more fire safe.

### CROSS-REFERENCE TO RELATED APPLICATIONS

N/A

### STATEMENT REGARDING FEDERALLY SPONSORED RESEARCH OR DEVELOPMENT

N/A

### REFERENCE TO A SEQUENCE LISTING, A TABLE, OR A COMPUTER PROGRAM, LISTING

N/A

### BACKGROUND OF THE INVENTION

There is much concern over the use of materials that burn easily and that give off toxic fumes when burning. Hence, much work is being done to find materials that are resistant to heat and flames or that are “fire safe”. The effort, in the market place as well in labs, is to find effective low-level additives to further reduce ignitability, or the heat release rate. Considering organization's needs for solutions with a commercial feasibility, the use of additives should not be viewed as competing with mixture of new polymeric materials but as a way of complementing, enhancing, and, in the best cases, increasing the flame-retardant performance of advanced polymers. Methods applied to date consists of different kinds of coating or insertion of additives to organic and non-organic polymers. However, neither method by itself is adequate.

The present invention related to thermal and flame protection will protect surfaces and material on which it is applied from high temperature, and more particularly, structure comprising a plurality of layers of composite material which integrate to provide predetermined load-behavior characteristics such as lower peak heat release rates, lower heat released per unit time, higher temperature gradient, low flame spread, high ignition delay, low peak heat release, low total heat release, high thermal stability, heat sink effect, a reduced amount of smoke and heat reflective property.

The principal object of the present invention is the provision of a new and improved system that integrates physical and chemical applications which will act as a heat barrier when exposed to fire.

Another object and advantage of the invention is the provision of a new method: it combines improved coating compositions and chemical additives creating a plurality of layers of composite material that interact chemically and create a strong fire barrier.

### SUMMARY OF THE INVENTION

A fire and heat resistant composition for providing or enhancing the fire resistance of a material. The composition consists of both chemical and physical integration. The fire-resistant composition of the present invention consists of a new formula that has particularly remarkable fire resistance, and can be used in a wide range of applications.

### DETAILED DESCRIPTION OF THE INVENTION

According to the invention, it has been discovered that a fire-resistant barrier can be constructed by incorporating physical and chemical treatments. The structure is comprised of a plurality layers of composite material which is integrated to provide predetermined load-behavior characteristics. When a material combination of a reinforcing glass and graphite fiber applied to a surface and the coated surface is subjected to a flame, the graphite fiber slowly disintegrates while the reinforcing glass material is fused together and creates the heat barrier. In the case of radome or armid related applications the structure will still be safe because it consists of polyethylene fibers which have peak and integrated heat releases per unit time below 50-60 kW/m̂2. The composites with the glass and graphite fiber reinforcement transmits less smoke and gives less output than composites with organic fibers such as ultra high molecular weight polyethylene or armid fiber due to their combustible nature. In the present invention we discover that the higher the heat flux, the shorter the time before ignition. In order to ensure an adequate response time and minimize the spread of fire we elect to construct a plurality of layer composites to provide a degree of glass thickness, which will reinforce the composites due to its thermal conductivity. We found that 3-5 combined coating thickness of the composite form a multi layer coating with a different burning rate and a low flame spread. In order to further delay ignition we applied 0.1-0.5 percent of boron oxide and or phosphorus. When applying plurality layers of composites to achieve the desired thickness we had to solve the coating integrity and to avoid its rigidity; therefore, we applied bonding coatings and elasticity-means which consist of urea, urea formaldehyde, and zirconium dioxide and chromium oxide. Another aspect of this invention relates to the heat reflective properties consisting of a reflective pigment such as titanium dioxide (TiCii) or, pearlescent pigments comprising TiO1 deposited on mica, and various infrared reflective clays, for ignition retardation. It was discovered that the reflective pigments enhance the ability of a material to resist ignition. Alumina trihydrate (ATH) and magnesium hydroxide decomposes endothermically and removes heat so that all of the applied heat is not directed at the polymer. They also release water and some of the energy is taken on by the water. One of the most interesting discoveries of this invention was in the additive route. The synthesis of such additives creates an application that is more fire safe. Phenolic and polyimide composites smoke less, have low flame spread, high ignition delay, low peak release, low total heat release, and high oxygen index. They tend to insulate the core of composite structure and render less structural damage. The additive is a chemical solution which is added to the polymer, either in a physical or a chemical fashion, making that material more resistant to burning. The additives indude alumina trihydrate and magnesium hydroxide, halogens, phosphorus, antimony, and synergistic combinations of these, and might indude nitrogen or other elements. The pretreatment of polymers combine with multi-layers of fire resistance means create a new method in fire resistance applications and it is more likely to be a fire safe application

1. A load-manner composite material structure with integrated chemical and physical thermal and flame protection, said structure comprising of a plurality of layers of composite material; said layers are integrated to provide predetermined load-behavior characteristics such as lower peak heat release rates, lower heat released per unit time, higher temperature gradient, low flame spread, high ignition delay, low peak heat release, low total heat release, high thermal stability, heat sink effect, a reduced amount of smoke and heat reflective property; Said layers including a plurality of chemical layers, and physical coating outer layers on an outer surface of said structure; said outer layers and each of said inner layers includes a mix of composite material that maintains its structural integrity at high temperatures; Said outer layers include a lower heat released per unit time type of but not limited to fiber reinforcement and elastic bond flame barrier that are embedded in said mix material and that is sufficiently flame resistant to prevent and or lower the penetration rate of a flame when said outer surface is directly exposed to a fire; and each of said inner layers in said mix material is sufficiently strong to provide predetermined load-bearing characteristics as described above.

2. A structure as described in claim 1, in which the flame barrier comprises a reinforcing glass and graphite fiber, in special application such as ballistic armor the use of armid and radome-related applications may use.

3. The structure of claim 2 wherein said fabric is polyethylene fibers that materials that exhibit peak and integrated heat releases per unit time below 50-60 kW/m̂

4. A structure as described in claim 1, in which the flame barrier comprises contain chemical additives are naturally more fire safe; The additive said means a chemical solution is added to the polymer, either in a physical or a chemical fashion, making that material more resistant to burning.

5. The additives as described in claim 4 include alumina trihydrate and magnesium hydroxide, halogens, phosphorus, antimony, and synergistic combinations of these, and might include nitrogen or other elements.

6. A structure as described in claim 3, in which the flame barrier comprises contains alumina trihydrate (ATH) and magnesium hydroxide decomposes endothermically and removes heat so that all of the applied heat is not directed at the polymer.

7. A structure as described in claim 3, in which the flame barrier comprises that flame is quenched contains Halogens, mainly bromine compounds and also chlorine compounds, form HX in the vapor phase.

8. A structure as described in claim 1, in which the flame barrier comprises heat reflective properties consists of reflective pigments such as titanium dioxide (TiCiᵢ) or pearlescent pigments comprising of TiO₁ deposited on mica, and various infrared reflective clays, for ignition retardation.

9. A structure as described in claim 1, in which the flame barrier comprises contains heat sink composite is an important mode including additives such as melamine in lower-temperature polymers such as urethane foams.

10. A structure as described in claim 1, in which the flame barrier comprises heat sink consists of a char former blend from the very stable and non-reactive triphenyl phosphine and or biphenyl phosphate.

11. A structure as described in claim 1, in which the flame barrier comprises flame-retardant effect consists of siyrenics and polyarnidea from the addition of approximately 5 percent of melamine and/or approximately 5 percent of triphenylphosphine oxide.

12. A structure as described in claim 1, in which the flame barrier comprises a flame-retardant also consists of the additive such as metal nitrate.

13. A structure as described in claim 1, in which the flame barrier comprises a low rate of char formation consists of a combinations of two phosphorus-containing additives, one being melamine phosphate and the other being a phosphonaie ester.

14. A structure as described in claim 1, in which the flame barrier comprises a flame retardant material including siloxane units in polymers, low levels of silicone structures such as mica or wollastoeite creates a reduction rate of heat release.

15. A structure as described in claim 1, in which the flame barrier comprises a delay in fire initiation consists of 0.1-0.5 percent of boron oxide and or phosphorus.

16. A structure as described in claim 1, in which the flame barrier comprises composite stability consists of phospharm phosphorus nitrides, and oxynitrides.

17. A structure as described in claim 1, in which the flame barrier helps prevent the burning away of char, is a 10-15 percent ceramic, a granite powder, and or glassy protective layer.

18. A structure as described in claim 1, in which the flame barrier comprises low-smoke consists of oxides and oxygen acid salts such as oxide and zinc borate.

19. A structure as described in claim 1, in which the flame barrier comprises a higher temperature incline, consists of 3-5 combined coating thickness of the composite.

20. A structure as described in claim 19, in which the flame barrier comprises a ticker coatings and elasticity means consists of urea, urea formaldehyde, zirconium dioxide and chromium oxide.
